(19) United States
(12) Patent Application Publication
(10) Pub. No.: US 2026/0145435 A1
(43) Pub. Date: May 28, 2026

(54) LIQUID LEVEL DETECTION UNIT AND LIQUID EJECTION DEVICE

(71) Applicant: SEIKO EPSON CORPORATION, Tokyo (JP)

(72) Inventor: Seiji TOJO, SHIOJIRI-SHI (JP)

(21) Appl. No.: 19/393,754

(22) Filed: Nov. 19, 2025

(30) Foreign Application Priority Data
Nov. 22, 2024 (JP) 2024-203934

(51) Int. Cl. B41J 2/175; G01F 23/02

(52) U.S. Cl. CPC B41J 2/17566; G01F 23/02; B41J 2002/17573

(57) ABSTRACT

A liquid level detection unit includes a liquid level tube extending along a height direction and opening to atmosphere in an upward direction; an inflow section connected to a flow path that causes liquid to flow into the liquid level tube from a tank connected to a liquid ejection head that ejects liquid; a reading section that outputs to a control section a reading result obtained by reading the liquid level of the liquid in the liquid level tube; and a base section in which the liquid level tube, the inflow section, and the reading section are provided, wherein the liquid level tube is light-transmissive.

The present application is based on, and claims priority from JP Application Serial Number 2024-203934, filed Nov. 22, 2024, the disclosure of which is hereby incorporated by reference herein in its entirety.

### BACKGROUND

### 1. Technical Field

The present disclosure relates to a liquid level detection unit and a liquid ejection device.

### 2. Related Art

For example, JP-A-2020-128064 discloses a liquid ejection device including a liquid ejection head that ejects a liquid from a tank and a sensor module that detects light from the tank. In such a liquid ejection device, the liquid level of the liquid in the tank is detected based on a detection signal from the sensor module, which is an example of a liquid level detection unit.

However, in such a liquid ejection device, it is necessary to install the liquid level detection unit on a side surface of the tank in order to detect light from the tank. Therefore, the liquid level detection unit cannot be installed at a position separated from the tank. Therefore, it is desired to improve the installation flexibility of the liquid level detection unit.

### SUMMARY

A liquid level detection unit for solving the above problem includes a liquid level tube extending along a height direction and opening to atmosphere in an upward direction; an inflow section connected to a flow path that causes liquid to flow into the liquid level tube from a tank connected to a liquid ejection head that ejects liquid; a reading section that outputs to a control section a reading result obtained by reading the liquid level of the liquid in the liquid level tube; and a base section in which the liquid level tube, the inflow section, and the reading section are provided, wherein the liquid level tube is light-transmissive and a height of a reference bottom surface of the liquid level tube is the same as a height of a reference bottom surface of the tank.

A liquid ejection device for solving the above problem includes a liquid ejection head configured to eject a liquid; a tank connected to the liquid ejection head; a liquid level detection unit for detecting a liquid level of the liquid in the tank; a flow path for guiding the liquid to flow from the tank into the liquid level detection unit; and a control section, wherein the liquid level detection unit includes a liquid level tube extending along a height direction and opening to atmosphere in an upward direction, an inflow section to which the flow path is connected, a reading section that outputs to the control section a reading result obtained by reading the liquid level of the liquid in the liquid level tube, and a base section in which the liquid level tube, the inflow section, and the reading section are provided, the liquid level tube is light-transmissive a height of a reference bottom surface of the liquid level tube is the same as a height of a reference bottom surface of the tank, and the control section detects a liquid level of the liquid in the tank based on a reading result by the reading section.

### BRIEF DESCRIPTION OF THE DRAWINGS

FIG. 1 is a schematic view of a liquid ejection device according to a first embodiment.

FIG. 2 is a schematic view of the liquid ejection device of the first embodiment.

FIG. 3 is a schematic view of a liquid level tube of the first embodiment.

FIG. 4 is a side view of a liquid level detection unit of the first embodiment.

FIG. 5 is a front view of the liquid level detection unit of the first embodiment.

FIG. 6 is a schematic view of a captured image according to the first embodiment.

FIG. 7 is a schematic view of a corrected image according to the first embodiment.

FIG. 8 is a side view of a liquid level detection unit of a second embodiment.

FIG. 9 is a front view of a liquid level detection unit of the second embodiment.

FIG. 10 is a schematic view of a liquid ejection device according to a third embodiment.

FIG. 11 is a schematic view of a liquid ejection device according to a fourth embodiment.

### DESCRIPTION OF EMBODIMENTS

### First Embodiment

Hereinafter, an embodiment of a liquid ejection device including a liquid level detection unit will be described with reference to the drawings. In the following description, in a state where the liquid ejection device is installed on a horizontal surface, an axis intersecting the horizontal surface is defined as a Z-axis, an axis intersecting the Z-axis is defined as an X-axis, and an axis intersecting the X-axis and the Z-axis is defined as a Y-axis. One direction along the X-axis is defined as a first width direction X1, and the other direction along the X-axis is defined as a second width direction X2. The direction along the X-axis is an example of a width direction. One direction along the Y-axis is defined as a forward direction Y1, and the other direction along the Y-axis is defined as a rearward direction Y2. The direction along the Y-axis is an example of a front-rear direction. An upward direction along the Z-axis is defined as an upward direction Z1, and a downward direction along the Z-axis is defined as a downward direction Z2. The direction along the Z-axis is an example of a height direction. Viewing from the forward direction Y1 is simply referred to as a front view. Viewing from the direction along the X-axis is simply referred to as a side view.

### Configuration of Liquid Ejection Device 11

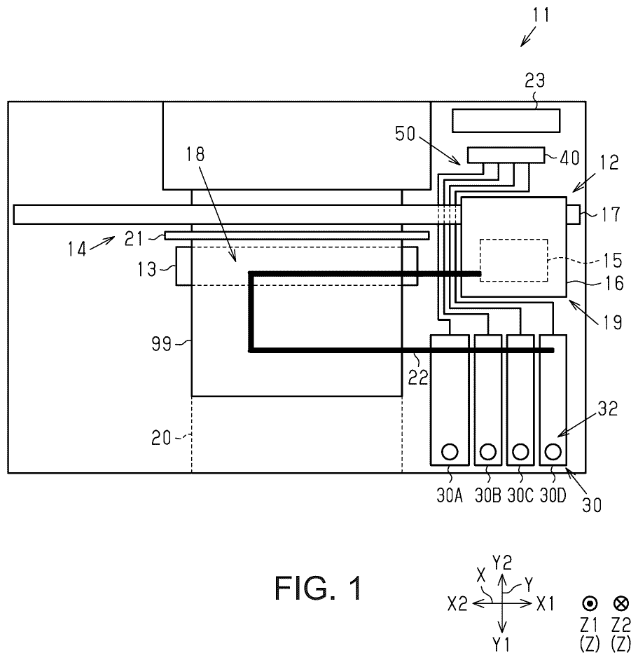

As illustrated in FIG. 1, a liquid ejection device 11 is configured to eject liquid onto a medium 99 to perform printing. The liquid ejection device 11 may be an ink jet printer that ejects ink, which is an example of a liquid, onto the medium 99 to perform printing.

The liquid ejection device 11 includes a liquid ejection section 12, a medium support section 13, and a transport section 14. The liquid ejection section 12 is configured to eject liquid onto a medium 99. The liquid ejection section 12 is configured to eject liquid onto the medium 99 supported by the medium support section 13. The liquid ejection section 12 is configured to eject liquid onto the medium 99 transported to the forward direction Y11.

The liquid ejection section 12 includes a liquid ejection head 15, a carriage 16, and a carriage guide 17. That is, the liquid ejection device 11 includes the liquid ejection head 15, the carriage 16, and the carriage guide 17.

The liquid ejection head 15 is configured to eject liquid. The liquid ejection head 15 of the present embodiment ejects the liquid toward the downward direction Z2. The liquid ejection head 15 is configured to be supported on the bottom surface of the carriage 16. The liquid ejection head 15 prints an image on the medium 99 by ejecting liquid onto the medium 99.

The carriage 16 is configured to support the liquid ejection head 15. The carriage 16 is supported by a carriage guide 17. The carriage guide 17 is configured to extend along the X-axis. The carriage 16 is configured to reciprocate along the carriage guide 17 by a drive force from a carriage drive section (not illustrated).

By this, the carriage 16 is configured to move along the X-axis in a state of supporting the liquid ejection head 15. That is, the liquid ejection head 15 is movable along the X-axis. The carriage 16 is configured to move along the X-axis between the print region 18 and the retraction region 19.

The print region 18 is configured to print on the medium 99. The print region 18 is provided at the center of the liquid ejection device 11. The retraction region 19 is a region for retracting the liquid ejection head 15 when the liquid ejection head 15 does not perform printing. The retraction region 19 is provided in the first width direction X1 with respect to the print region 18. That is, the retraction region 19 is provided in the first width direction X1 with respect to the center of the liquid ejection device 11. The retraction region 19 may be a region where maintenance of the liquid ejection head 15 is performed. The carriage 16 waits at a standby position in the retraction region 19. When the carriage 16 is disposed at the standby position, the position at which the liquid ejection head 15 is disposed corresponds to an example of a predetermined position.

The medium support section 13 is configured to support the medium 99. The medium support section 13 is provided so as to extend along the X-axis. The medium support section 13 is configured to support the medium 99 transported by the transport section 14. The medium support section 13 is provided at a position facing the liquid ejection head 15 in the print region 18. The medium support section 13 is configured to support the medium 99 when the liquid ejection head 15 ejects liquid toward the medium 99.

The transport section 14 is configured to transport the medium 99 along the transport path 20. The transport path 20 is a path along which the medium 99 is transported in the transport direction. The liquid ejection device 11 includes a transport path 20. The transport section 144 is configured to transport the medium 99 in the forward direction Y1 while the medium 99 is in a state of being supported by the medium support section 13. The forward direction Y1 corresponds to an example of a transport direction.

The transport section 14 may include a plurality of roller pairs. The transport section 14 may include a transport roller pair 21. The transport roller pair 21 is configured to transport the medium 99 upstream of the medium support section 13 in the transport direction.

The liquid ejection device 11 includes a tank 30. The tank 30 stores the liquid to be ejected onto the medium 99. The liquid ejection device 11 may include a plurality of tanks 30A to 30D. The liquid ejection device 11 may include a plurality of tanks 30A to 30D corresponding to the colors of the liquid.

The plurality of tanks 30A to 30D are configured in the same manner. Hereinafter, the plurality of tanks 30A to 30D may be collectively referred to as the tank 30. At least any combination of the plurality of tanks 30A to 30D may have different sizes or capacities.

The plurality of tanks 30A to 30D are provided in the first width direction X1 with respect to the transport path 20. The plurality of tanks 30A to 30D are provided in the forward direction Y1 of the liquid ejection head 15 disposed at the standby position.

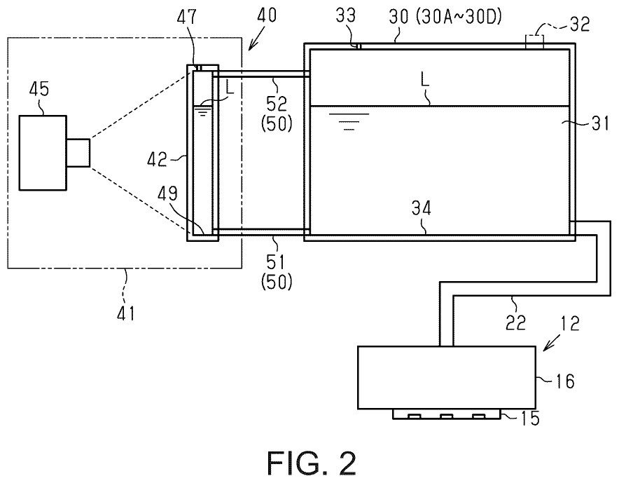

As illustrated in FIG. 2, each of the plurality of tanks 30A to 30D includes a liquid accommodation chamber 31. The liquid accommodation chamber 31 is configured to contain a liquid. The liquid accommodation chamber 31 may be a container that contains a liquid.

Each of the plurality of tanks 30A to 30D includes an inlet section 32. The inlet section 32 includes an injection port into which a liquid is injected. The inlet section 32 is provided in an upward direction Z1 of each of the plurality of tanks 30A to 30D.

Each of the plurality of tanks 30A to 30D includes a tank atmosphere opening section 33. The tank atmosphere opening section 33 is provided in the upward direction Z1 of each of the plurality of tanks 30A to 30D. The tank atmosphere opening section 33 may be a hole for releasing the air in the tank 30 to the outside.

As illustrated in FIG. 1, the liquid ejection device 11 includes a supply flow path 22. The liquid ejection device 11 may include a plurality of supply flow paths 22 corresponding to the plurality of tanks 30A to 30D. The supply flow path 22 is a flow path that connects the plurality of tanks 30A to 30D and the liquid ejection head 15. That is, the plurality of tanks 30A to 30D are connected to the liquid ejection head 15 via the supply flow path 22. The supply flow path 22 may be, for example, a tube.

The liquid ejection device 11 includes a control section 23. The control section 23 comprehensively controls the liquid ejection device 11. The control section 23 controls various operations executed by the liquid ejection device 11. The control section 23 can be configured as a hardware circuit including α: one or more processors that execute various processes according to a computer program, β: one or more dedicated hardware circuits that execute at least a part of various processes, or γ: a combination thereof. The hardware circuit is, for example, an application specific integrated circuit. The processor includes a CPU and a memory, such as a RAM and a ROM, and the memory stores program code or instructions configured to cause the CPU to execute processes. Memory or computer readable medium includes any readable medium that can be accessed by a general purpose or dedicated computer.

The control section 23 displays various types of information on a display section (not illustrated). The control section 23 receives an instruction from a user through an operation section (not illustrated). The liquid ejection device 11 may be capable of communicating with a terminal device (not illustrated). The control section 23 may receive an instruction from the user from the terminal device.

The liquid ejection device 11 includes a liquid level detection unit 40. The liquid level detection unit 40 outputs, to the control section 23, information that enables detection of the liquid level L of the liquid contained in each of the plurality of tanks 30A to 30D. The liquid level L indicates the height of the liquid surface of the liquid.

The liquid level detection unit 40 is provided in the first width direction X1 with respect to the transport path 20. The liquid level detection unit 40 is provided in the rearward direction Y2 with respect to the liquid ejection head 15 disposed at the standby position.

As described above, in the first embodiment, when the liquid ejection head 15 is disposed at the standby position, the plurality of tanks 30A to 30D and the liquid level detection unit 40 are provided at positions sandwiching the liquid ejection head 15 in the direction along the Y-axis. That is, the plurality of tanks 30A to 30D and the liquid level detection unit 40 are provided at positions sandwiching a movement range in which the liquid ejection head 15 can move. At least a part of the liquid level detection unit 40 may be provided at a position overlapping at least a part of the plurality of tanks 30A to 30D in the front view.

The liquid ejection device 11 includes a coupling path 50. The liquid ejection device 11 may include a plurality of coupling paths 50 corresponding to the plurality of tanks 30A to 30D. The plurality of coupling paths 50 connect the plurality of tanks 30A to 30D and the liquid level detection unit 40.

As illustrated in FIG. 2, each of the plurality of coupling paths 50 includes a flow path 51. That is, the liquid ejection device 11 includes a plurality of flow paths 51. The flow path 51 is configured to connect the tank 30 and the liquid level detection unit 40 to each other. The flow path 51 is connected to the downward direction Z2 side of the tank 30. The flow path 51 is configured to guide the liquid contained in the tank 30 into the liquid level detection unit 40.

Each of the plurality of coupling paths 50 includes a communication path 52. That is, the liquid ejection device 11 includes a plurality of communication paths 52. The communication path 52 is configured to connect the tank 30 and the liquid level detection unit 40 to each other. The communication path 52 is connected to the upward direction Z1 side of the tank 30. The communication path 52 is configured to guide the air in the liquid level detection unit 40 into the tank 30 by connecting the tank 30 and the liquid level detection unit 40.

### Configuration of Liquid Level Detection Unit 40

Here, the configuration of the liquid level detection unit 40 will be described with reference to FIGS. 2 to 5. In FIG. 2, the plurality of tanks 30A to 30D will be described with the tank 30 as a representative.

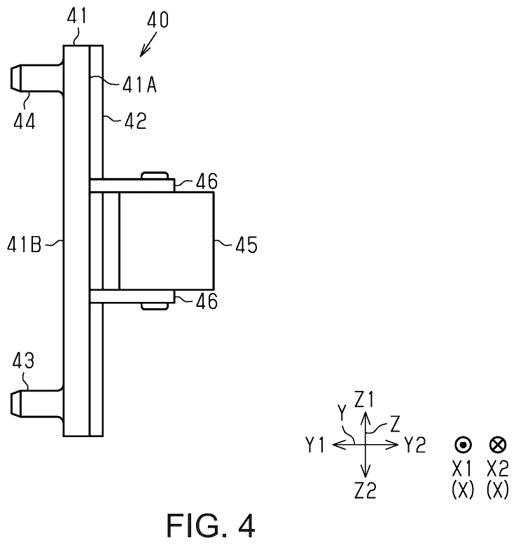

As illustrated in FIG. 4, the liquid level detection unit 40 includes a base section 41. The liquid level detection unit 40 includes a liquid level tube 42, an inflow section 43, and a communication section 44. The liquid level detection unit 40 may include a plurality of liquid level tubes 42, a plurality of inflow sections 43, and a plurality of communication sections 44 so as to correspond to the plurality of tanks 30A to 30D. The liquid level detection unit 40 includes a reading section 45 and a support section 46.

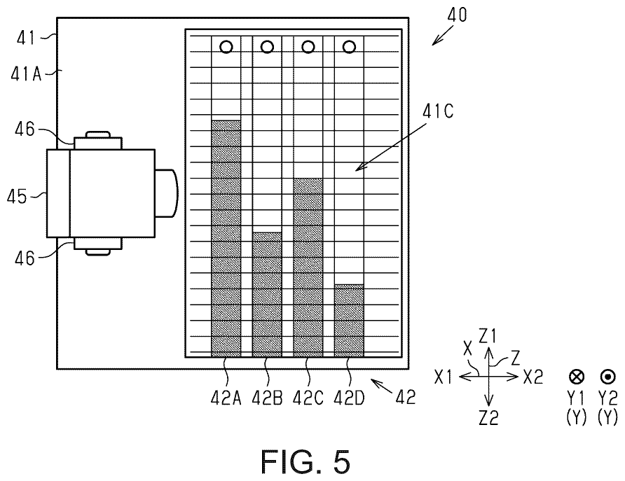

As illustrated in FIGS. 4 and 5, the base section 41 is a member that serves as a base of the liquid level detection unit 40. The base section 41 is a member that holds the liquid level tube 42, the inflow section 43, the communication section 44, and the reading section 45. That is, the base section 41 is provided with the liquid level tube 42, the inflow section 43, the communication section 44, and the reading section 45. The base section 41 may be provided in a plate shape. The base section 41 is made of resin, but may be made of a material other than resin. The base section 41 may have a color different from that of the liquid so that the liquid level L of the liquid contained in the liquid level tube 42 can be read by the reading section 45.

The base section 41 includes a first surface 41A and a second surface 41B. The second surface 41B is the back surface of the first surface 41A. The liquid level tube 42, the reading section 45, and the support section 46 are provided at the first surface 41A side. An inflow section 43 and a communication section 44 are provided at the second surface 41B side.

As illustrated in FIG. 5, the base section 41 includes a plurality of reference lines 41C. That is, the liquid level detection unit 40 includes a plurality of reference lines 41C. The plurality of reference lines 41C are provided on the first surface 41A. The reference lines 41C are provided in a region where the liquid level tube 42 is disposed.

The plurality of reference lines 41C are lines indicating references for the liquid level L of the liquid level tube 42. The plurality of reference lines 41C are lines indicating the reference of the liquid level L of each of the plurality of liquid level tubes 42A to 42D. The plurality of reference lines 41C are provided so as to be arranged in the direction along the Z-axis.

The liquid level tube 42 is provided at the first surface 41A side. The plurality of liquid level tubes 42A to 42D are provided at the first surface 41A side. The plurality of liquid level tubes 42A to 42D are provided so as to be arranged in the direction along the X-axis. That is, the plurality of liquid level tubes 42A to 42D are provided so as to be aligned in a direction included in the first surface 41A and intersecting the Z-axis.

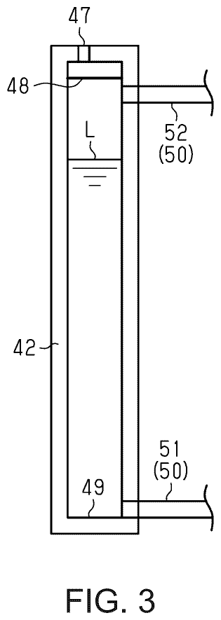

As illustrated in FIGS. 2 and 3, the liquid level tube 42 is configured to contain a liquid. The liquid level tube 42 is light-transmissive. The liquid level tube 42 may be transparent or not transparent as long as the liquid level L of the liquid contained therein can be read by the reading section 45. The liquid level tube 42 has a tubular shape extending in the direction along the Z-axis. The liquid level tube 42 is configured to be open to atmosphere in the upward direction Z1.

The liquid level tube 42 is a member into which the liquid from the tank 30 flows. The liquid level tube 42 has a smaller liquid storage capacity than the tank 30. The plurality of liquid level tubes 42A to 42D are members into which the liquid from the plurality of tanks 30A to 30D corresponding thereto flows.

As illustrated in FIG. 2, the height of the reference bottom surface 49 of the liquid level tube 42 is the same as the height of the reference bottom surface 34 of the tank 30. That is, the liquid level detection unit 40 is disposed such that the reference bottom surface 49 of the liquid level tube 42 and the reference bottom surface 34 of the tank 30 are at the same height.

By this, when the liquid in the tank 30 flows into the liquid level tube 42, the liquid level L of the liquid level tube 42 becomes the same as the liquid level L of the tank 30. That is, the liquid levels L of the plurality of liquid level tubes 42 are the same as the liquid levels L of the plurality of tanks 30A to 30D corresponding thereto.

As illustrated in FIG. 3, the liquid level tube 42 includes a liquid level tube atmosphere opening section 47. The liquid level tube atmosphere opening section 47 is provided in the upward direction Z1 of the liquid level tube 42. The liquid level tube atmosphere opening section 47 is a hole for releasing air inside the liquid level tube 42 to the outside.

The liquid level tube atmosphere opening section 47 includes a moisture-permeable membrane 48. That is, the liquid level tube 42 includes the moisture-permeable membrane 48. The moisture-permeable membrane 48 is provided at the upward direction Z1 side of the liquid level tube 42. The moisture-permeable membrane 48 is provided so as to cover the liquid level tube atmosphere opening section 47 from the inside. The moisture-permeable membrane 48 is a membrane that allows air to pass through but prevents liquid from passing through. In this way, the moisture-permeable membrane 48 is provided in the liquid level tube atmosphere opening section 47 so as to communicate with atmosphere.

As illustrated in FIG. 4, the inflow section 43 is provided in the second surface 41B. The inflow section 43 is provided so as to protrude from the second surface 41B toward the forward direction Y1. The inflow section 43 is a member for guiding the liquid into the liquid level tube 42. The plurality of inflow sections 43 are members for guiding the liquid into the corresponding liquid level tubes 42A to 42D.

The inflow section 43 may be configured to penetrate the base section 41. The flow path 51 is connected to the inflow section 43. As a result, the tank 30 and the liquid level tube 42 are connected via the flow path 51. The flow path 51 causes the liquid in the tank 30 to flow from the tank 30 into the liquid level tube 42. The plurality of flow paths 51 cause the liquid in the plurality of tanks 30A to 30D to flow from the corresponding tanks 30A to 30D into the liquid level tanks 42A to 42D.

The communication section 444 is provided in the second surface 41B. The communication section 44 is provided so as to protrude from the second surface 41B toward the forward direction Y1. The communication section 44 is a member for communicating the tank 30 and the liquid level tube 42. The plurality of communication sections 44 are members for communicating the plurality of tanks 30A to 30D and the plurality of liquid level tubes 42A to 42D corresponding thereto.

The communication section 44 may be configured to penetrate the base section 41. The communication path 52 is connected to the communication section 44. The tank 30 and the liquid level tube 42 are thereby connected via the communication path 52. The communication path 52 communicates the tank atmosphere opening section 33 of the tank 30 with the liquid level tube 42. The plurality of communication paths 52 communicate the tank atmosphere opening sections 33 of the plurality of corresponding tanks 30A to 30D with the plurality of liquid level tubes 42A to 42D.

As illustrated in FIGS. 4 and 5, the reading section 45 is provided at the first surface 41A side. The plurality of liquid level tubes 42A to 42D may be provided so as to be arranged in the direction along the X-axis. The reading section 45 may be provided in the direction in which the plurality of liquid level tubes 42A to 42D are arranged at the first surface 41A side. In other words, the reading section 45 may be provided at the first surface 41A side, further in the first width direction X1 than the plurality of liquid level tubes 42A to 42D.

The reading section 45 is supported by the support section 46 at the first surface 41A side. The reading section 45 is supported by the support section 46 so as to be facing in a first direction. The first direction is different from a perpendicular direction that is perpendicular to the first surface 41A, and is a direction inclined from the perpendicular direction with respect to the first surface 41A. That is, the first direction is different from the horizontal direction and is a direction inclined from the horizontal direction.

The support section 46 is provided on the first surface 41A. The support section 46 is provided so as to protrude from the first surface 41A toward the rearward direction Y2. The support section 46 is configured to support the reading section 45. The support section 46 supports the reading section 45 such that the reading section 45 faces in the first direction.

The reading section 45 may be a camera. The reading section 45 captures an image of the liquid level tube 42. The reading section 45 captures an image of the plurality of liquid level tubes 42A to 42D from the first direction. The reading section 45 is configured to read the liquid level L of the liquid level tube 42. The reading section 45 is configured to read the liquid level L of each of the plurality of liquid level tubes 42A to 42D.

The reading section 45 outputs the captured image data to the control section 23. That is, the reading section 45 outputs the reading result obtained by reading the liquid level L of the liquid level tube 42 to the control section 23. The reading section 45 outputs the reading result of reading the liquid level L of each of the plurality of liquid level tubes 42A to 42D to the control section 23.

### Liquid Level Detection Control Process

Next, the liquid level detection control process will be described. The liquid level detection control process is a process executed by the control section 23. The liquid level detection control process is executed when the detection condition is satisfied. The detection condition may be satisfied when the power of the liquid ejection device 11 is turned on.

When the detection condition is satisfied, the control section 23 outputs a read command to the reading section 45. By this, the control section 23 acquires, from the reading section 45, the reading result by the reading section 45. The control section 23 acquires image data captured by the reading section 45 from the reading section 45.

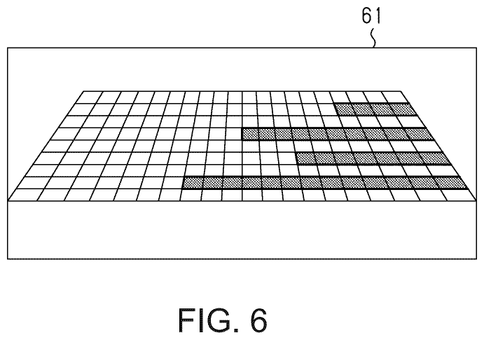

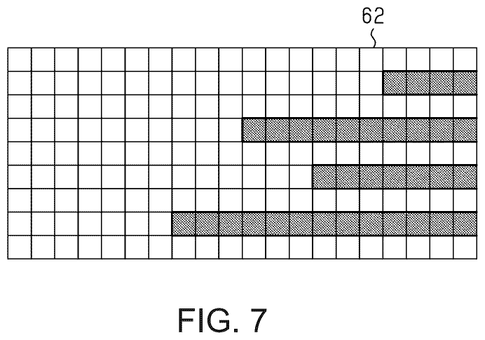

As illustrated in FIGS. 6 and 7, the control section 23 may generate corrected image data by correcting the acquired image data. Specifically, the control section 23 corrects a captured image 61, which is captured by the reading section 45, to a corrected image 62, which is from the perpendicular direction, according to the inclination angle of the first direction with respect to the perpendicular direction. The corrected image 62 is an image obtained by correcting the captured image 61 to a planar state. The inclination angle is a constant angle. The control section 23 may correct the captured image 61 into an enlarged corrected image 62.

As illustrated in FIG. 6, since the reading section 45 performs imaging from the first direction, the captured image 61 of the plurality of liquid level tubes 42A to 42D is distorted. Therefore, as illustrated in FIG. 7, the control section 23 corrects the captured image 61 into the corrected image 62, and by this, the distortion of the captured image 61 of the plurality of liquid level tubes 42A to 42D can be suppressed.

The control section 23 calculates the liquid level L of each of the plurality of liquid level tubes 42A to 42D based on the corrected image data. By this, the control section 23 can detect the liquid level L in the plurality of tanks 30A to 30D based on the reading result by the reading section 45.

### Operation and Effects of the First Embodiment

The operation and effects of the first embodiment will be described.

(1-1) The liquid level detection unit 40 includes the inflow section 43 to which is connected the flow path 51 for causing the liquid to flow from the tank 30 into the liquid level tube 42. The liquid level detection unit 40 includes a reading section 45 that outputs, to the control section 23, a reading result obtained by reading the liquid level L of the liquid in the liquid level tube 42. The liquid level detection unit 40 includes a base section 41 in which are provided a liquid level tube 42, an inflow section 43, and a reading section 45. The liquid level tube 42 is light-transmissive, and the height of the reference bottom surface 49 of the liquid level tube 42 is the same as the height of the reference bottom surface 34 of the tank 30. According to this configuration, the liquid level L in the tank 30 and the liquid level L in the liquid level tube 42 are the same. Therefore, the reading section 45 reads the liquid level L in the liquid level tube 42, and thus the liquid level L in the tank 30 can be read. By this, the installation location of the liquid level detection unit 40 is not limited to the side surface of the tank 30. Therefore, even in a state where the liquid level detection unit 40 is installed at a position separated from the tank 30, the liquid level L in the tank 30 can be read. In addition, by installing the liquid level detection unit 40 at a position separated from the tank 30, it is possible to suppress the miniaturization of the tank 30. Therefore, installation flexibility of the liquid level detection unit 40 can be improved.

(1-2) The liquid level detection unit 40 includes the plurality of liquid level tubes 42A to 42D and the plurality of inflow sections 43 for causing the liquid to flow from the plurality of tanks 30A to 30D into the plurality of liquid level tubes 42A to 42D. According to this configuration, the reading section 45 reads the liquid level L flowing into the plurality of liquid level tubes 42A to 42D, and thus the liquid level L in the plurality of tanks 30A to 30D corresponding to the plurality of liquid level tubes 42A to 42D can be read.

(1-3) The liquid level detection unit 40 includes the plurality of reference lines 41C, which indicate the reference of the liquid level L of the liquid level tube 42, so as to be arranged in the direction along the Z-axis of the liquid level tube 42. The reading section 45 is a camera. According to this configuration, the liquid level L in the liquid level tube 42 can be read by imaging the liquid level tube 42 with the camera. By this, the liquid level detection unit 40 can be provided with a simple configuration. In particular, the liquid level L in the plurality of liquid level tubes 42A to 42D can be read by imaging the plurality of liquid level tubes 42A to 42D all at once with the camera.

In addition, by imaging the plurality of reference lines 41C together with the liquid level tube 42 with the camera, it is possible to capture an image that improves the detection accuracy of the liquid level L in the liquid level tube 42 with reference to the plurality of reference lines 41C.

1-4 The base section 41 includes the first surface 41A. The liquid level tube 42 and the camera are provided at the first surface 41A side. The camera images the liquid level tube 42 from the first direction. The first direction is a direction inclined from a perpendicular direction that is perpendicular to the first surface 41A. According to this configuration, the camera can be disposed on the base section 41 alongside the liquid level tube 42, rather than in front of the liquid level tube 42. This enables the liquid level detection unit 40 to be made more compact in the perpendicular direction than in a case in which the camera is installed in front of the liquid level tube 42. Therefore, installation flexibility of the liquid level detection unit 40 can be improved.

(1-5) The liquid level tube 42 has the liquid level tube atmosphere opening section 47 in the upward direction Z1. According to this configuration, the liquid level tube atmosphere opening section 47 is provided in the upward direction Z1 of the liquid level tube 42, and thus the liquid level tube 42 can be open to atmosphere. This enables the liquid to flow smoothly from inside the tank 30 into the liquid level tube 42.

(1-6) The liquid level detection unit 40 includes the moisture-permeable membrane 48 that covers the liquid level tube atmosphere opening section 47. This configuration enables the liquid inside the liquid level tube 42 to be suppressed from leaking to the outside from the liquid level tube atmosphere opening section 47.

(1-7) The liquid level detection unit 40 includes the communication section 44. The communication section 44 communicates the liquid level tube 42 and the tank atmosphere opening section 33. According to this configuration, the communication section 44 is provided, and thus the liquid level tube 42 and the tank atmosphere opening section 33 can be in communication with each other. This enables the liquid level tube 42 to be open to atmosphere. Therefore, the liquid can be made to flow smoothly from the inside of the tank 30 into the liquid level tube 42.

(1-8) The control section 23 corrects, according to the inclination angle of the first direction with respect to the perpendicular direction, the captured image 61 captured by the camera to the corrected image 62, which is from the perpendicular direction. According to this configuration, even when the camera captures an image of the liquid level tube 42 from the first direction, which is inclined from the perpendicular direction, the captured image 61 can be corrected to the corrected image 62, which is from the perpendicular direction. By this, the detection accuracy of the liquid level L in the liquid level tube 42 can be improved based on the corrected image 62.

(1-9) Each of the plurality of tanks 30 includes the inlet section 32 into which the liquid is injected. According to this configuration, it is possible to detect the liquid level L of the liquid in the tank 30 that can be replenished with the liquid from outside via the inlet section 32.

(1-10) The plurality of tanks 30A to 30D and the liquid level detection unit 40 may be provided at positions sandwiching the movement range of the liquid ejection head 15 in the direction along the Y-axis. According to this configuration, the plurality of tanks 30A to 30D and the liquid level detection unit 40 can be disposed at different positions sandwiching the movement range of the liquid ejection head 15. Therefore, installation flexibility of the liquid level detection unit 40 can be improved.

(1-11) At least a portion of the liquid level detection unit 40 overlaps at least a portion of the plurality of tanks 30A to 30D in a front view. According to this configuration, the flow path 51 connecting the liquid level detection unit 40 and the plurality of tanks 30A to 30D can be shortened compared to a case where the liquid level detection unit 40 and the plurality of tanks 30A to 30D do not overlap in the front view. Therefore, it is possible to suppress an increase in the size of the device.

### Second Embodiment

Next, a second embodiment will be described. In the following description, redundant descriptions of configurations identical to those of the previously described embodiment will be omitted or simplified, and configurations that differ from the previously described embodiment will be detailed.

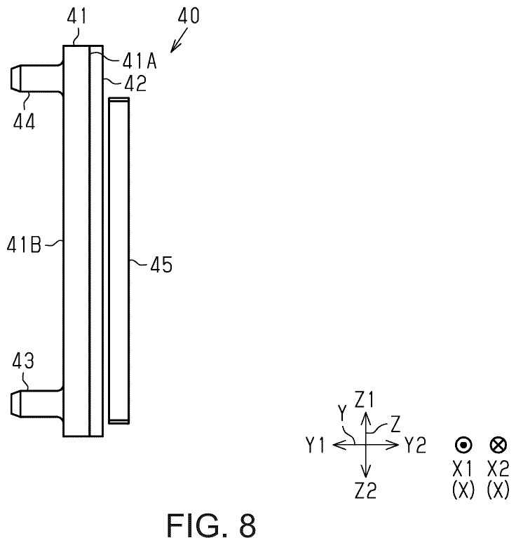

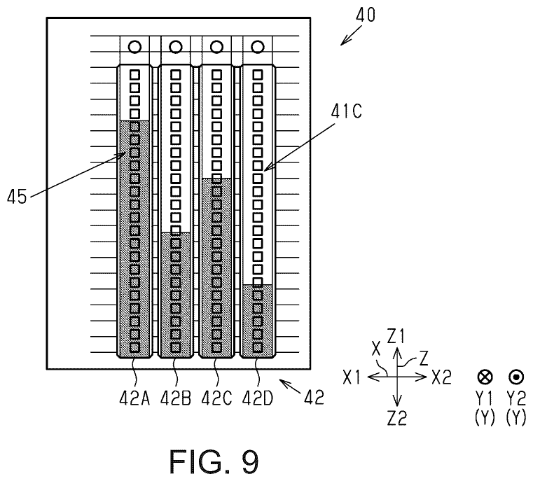

As illustrated in FIGS. 8 and 9, the reading section 45 may be a linear image sensor. The linear image sensor is provided along the Z-axis with respect to the liquid level tube 42. The reading section 45 may be a plurality of linear image sensors. The plurality of linear image sensors are provided along the Z-axis with respect to the plurality of liquid level tubes 42A to 42D.

The reading section 45 is provided at the first surface 41A side. The reading section 45 may be attached to the first surface 41A. The reading section 45 may be provided so as to overlap the liquid level tube 42 when viewed from the perpendicular direction, which is perpendicular to the first surface 41A. That is, the reading section 45 may be provided so as to overlap the liquid level tube 42 when viewed from the horizontal direction. The horizontal direction is a direction in which the liquid surface in the liquid level tube 42 perpendicularly intersects the liquid level tube 42. In the present embodiment, the horizontal direction is a direction along the Y-axis.

The linear image sensor receives the reflection light reflected by the liquid in the liquid level tube 42, converts the received light into an electric signal, and outputs a signal corresponding to the amount of received light to the control section 23. That is, the reading section 45 outputs the reading result obtained by reading the liquid level L of the liquid level tube 42 to the control section 23.

In this way, the linear image sensor is a sensor that reads the liquid level L of the liquid level tube 42. The plurality of linear image sensors are sensors that read the liquid level L of each of the plurality of liquid level tubes 42A to 42D.

The control section 23 detects the liquid level L of the liquid level tube 42 based on the signal from the reading section 45. The control section 23 detects the liquid level L of each of the plurality of liquid level tubes 42A to 42D based on the signal from the reading section 45.

### Operations and Effects of Second Embodiment

Operations and effects of the second embodiment will be described.

(2-1) The reading section 45 is a linear image sensor. The linear image sensor is provided so as to overlap the liquid level tube 42 when viewed from the perpendicular direction with respect to the first surface 41A. According to this configuration, the liquid level detection unit 40 can be downsized in the perpendicular direction as compared with a case where the reading section 45 is a camera. Compared to a case where the reading section 45 is a camera, the liquid level detection unit 40 can be reduced in size also in the direction in which the plurality of liquid level tubes 42A to 42D are arranged. Therefore, installation flexibility of the liquid level detection unit 40 can be improved.

### Third Embodiment

Next, a third embodiment will be described.

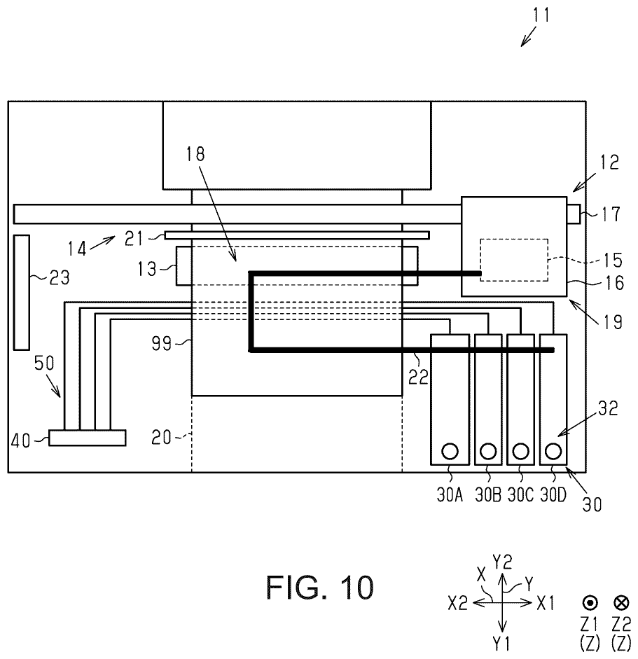

As illustrated in FIG. 10, in the third embodiment, the liquid level detection unit 40 may be provided further in the second width direction X2 than the transport path 20. The plurality of tanks 30A to 30D may be provided further in the first width direction X1 than the transport path 20. The control section 23 may be provided further in the second width direction X2 than the transport path 20.

In this manner, the plurality of tanks 30A to 30D and the liquid level detection unit 40 may be provided at positions sandwiching the transport path 20 in the direction along the X-axis. At least a portion of the liquid level detection unit 40 may be provided at a position overlapping at least a portion of the plurality of tanks 30A to 30D in side view.

### Operations and Effects of Third Embodiment

Operations and effects of the third embodiment will be described.

(3-1) The plurality of tanks 30A to 30D and the liquid level detection unit 40 are provided at positions sandwiching the transport path 20 in the direction along the X-axis. According to this configuration, the plurality of tanks 30A to 30D and the liquid level detection unit 40 can be disposed at different positions with the transport path 20 interposed therebetween. Therefore, installation flexibility of the liquid level detection unit 40 can be improved. In particular, when the plurality of tanks 30A to 30D are disposed further in the first width direction X1 than the transport path 20, further in the second width direction X2 than the transport path 20 is more likely to become dead space. Therefore, by disposing the liquid level detection unit 40 further in the second width direction X2 than the transport path 20, it is possible to suppress an increase in the size of the liquid ejection device 11.

(3-2) At least a portion of the liquid level detection unit 40 overlaps at least a portion of the plurality of tanks 30A to 30D in side view. According to this configuration, the flow path 51 connecting the liquid level detection unit 40 and the plurality of tanks 30A to 30D can be shortened compared to a case where the liquid level detection unit 40 and the plurality of tanks 30A to 30D do not overlap in side view. Therefore, it is possible to suppress an increase in the size of the device.

### Fourth Embodiment

Next, a fourth embodiment will be described.

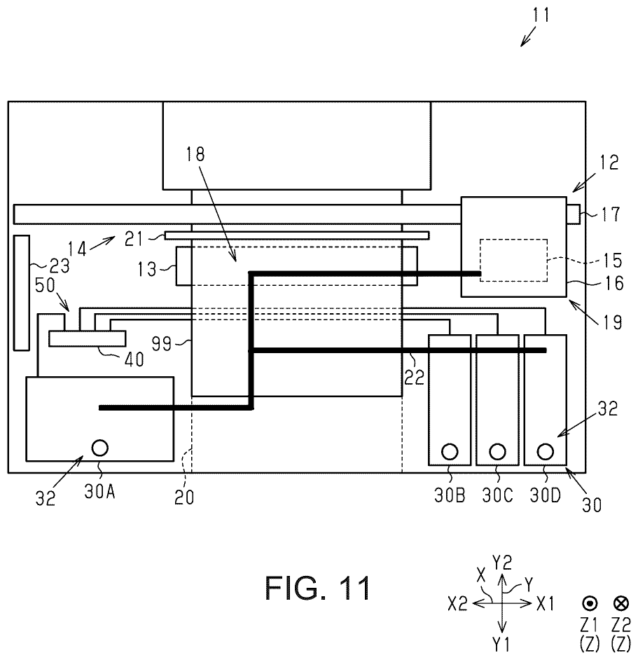

As illustrated in FIG. 11, in the fourth embodiment, the liquid level detection unit 40 and the tank 30A may be provided further in the second width direction X2 than the transport path 20. The tanks 30B to 30D may be provided further in the first width direction X1 than the transport path 20.

In this way, one or more tanks 30 among the plurality of tanks 30A to 30D and the liquid level detection unit 40 may be provided at positions sandwiching the transport path 20 in the direction along the X-axis. At least a portion of the liquid level detection unit 40 may be provided at a position overlapping in side view at least a portion of one or more of the tanks 30B to 30D, which are provided further in the first width direction X1 than the transport path 20.

### Operations and Effects of Fourth Embodiment

Operations and effects of a fourth embodiment will be described.

(4-1) The one or more tanks 30B to 30D and the liquid level detection unit 40 are provided at positions sandwiching the transport path 20 in the direction along the X-axis. According to this configuration, one or more tank of the tanks 30B to 30D and the liquid level detection unit 40 can be disposed at different positions with the transport path 20 interposed therebetween. Therefore, installation flexibility of the liquid level detection unit 40 can be improved.

(4-2) At least a portion of the liquid level detection unit 40 may overlap in side view at least a portion of one or more of the tank 30B to the 30D. According to this configuration, the flow path 51 connecting the liquid level detection unit 40 and the one or more tanks 30B to 30D can be shortened compared to a case where the liquid level detection unit 40 and the one or more tanks 30B to 30D do not overlap in side view. Therefore, it is possible to suppress an increase in the size of the device.

### Modifications

The present embodiment can be implemented with the following modifications. The embodiments and the following modifications can be implemented in combination with each other as long as there is no technical contradiction.

In the first embodiment, the support section 46 may support the reading section 45 so that the first direction is adjustable. The support section 46 may support the reading section 45 so as to fix the reading section 45 such that the first direction does not change.

In the first embodiment, the reading section 45 may be provided further in the second width direction X2 than the plurality of liquid level tubes 42A to 42D. The reading section 45 may be provided further in the upward direction Z1 than the plurality of liquid level tubes 42A to 42D. The reading section 45 may be provided further in the downward direction Z2 than the liquid level tubes 42A to 42D. That is, the first direction may be a direction inclined from the perpendicular direction of the first surface 41A toward the direction along the Z-axis. The first direction may be a direction inclined from the perpendicular direction of the first surface 41A toward both the direction along the X-axis and the direction along the Z-axis.

The detection condition may be satisfied when the power of the liquid ejection device 11 is turned off. The detection condition may be satisfied after the initialization of the liquid ejection device 11. The detection condition may be satisfied before the start of a print job for printing on at least one sheet of the medium 99. The detection condition may be satisfied whenever printing is performed on one sheet of the medium 99. The detection condition may be satisfied after the print job is completed.

The detection condition may be satisfied after maintenance of the liquid ejection head 15. The maintenance may be flushing. The flushing is an operation of ejecting liquid from the liquid ejection head 15. The maintenance may be cleaning. Cleaning is maintenance for forcibly discharging the liquid from the liquid ejection head 15, for example, by applying a negative pressure to the liquid ejection head 15.

The detection condition may be satisfied after the tank 30 is filled with the liquid. The detection condition may be satisfied after the tank 30 is initially filled with the liquid. The detection condition may be satisfied in response to an instruction from the user. The detection condition may be satisfied at predetermined intervals.

The tank 30 may not include the inlet section 32 as long as the tank 30 supplies the liquid to the liquid ejection head 15. The tank 30 may be supplied with liquid from an ink cartridge. The tank 30 may be supplied with the liquid from an ink tank.

Each of the plurality of tanks 30A to 30D may be disposed in the first width direction X1 with respect to the transport path 20 or may be disposed in the second width direction X2 with respect to the transport path 20. The liquid ejection device 11 may include one or more tanks 30, and may include one, two, three, or five or more tanks 30. In such a case, the number of the liquid level tubes 42, the inflow sections 43, the communication sections 44, the flow paths 51, and the communication paths 52 is the same as the number of the tanks 30.

The liquid level detection unit 40 and the plurality of tanks 30A to 30D may be provided at any position. The liquid level detection unit 40 and the plurality of tanks 30A to 30D may be provided at positions not sandwiching the transport path 20 in the direction along the X-axis. The liquid level detection unit 40 and the plurality of tanks 30A to 30D may be provided at positions that do not sandwich the movement range of the liquid ejection head 15 in the direction along the Y-axis. In the fourth embodiment, the liquid level detection unit 40 may be provided in the first width direction X1 with respect to the transport path 20.

The liquid level detection unit 40 may be provided at a position that does not overlap the plurality of tanks 30A to 30D in the front view. The liquid level detection unit 40 may be provided at a position that does not overlap the plurality of tanks 30A to 30D in side view.

The liquid level detection unit 40 may include a light source capable of irradiating the liquid level tube 42 with light. The light source may be configured by, for example, an LED, a fluorescent lamp, or the like. The light source may be provided on the base section 41. The light source may be provided in the reading section 45. The light source may be provided on a member different from the liquid level detection unit 40.

The inflow section 43 may be provided separately from the base section 41 or may be provided integrally with the base section 41. The communication section 44 may be provided separately from the base section 41 or may be provided integrally with the base section 41.

As long as the liquid level tube 42 is provided at the first surface 41A side, the liquid level tube 42 may be provided on the first surface 41A itself or may be provided on a surface different from the first surface 41A. For example, the liquid level tube 42 may be provided in a recess section in the first surface 41A. For example, the liquid level tube 42 may be provided on a protrusion section in the first surface 41A.

As long as the read region of the liquid level tube 42 that is read by the reading section 45 is light-transmissive, regions other than the read region need not be light-transmissive. The liquid level tube 42 may have a cylindrical shape or a prismatic shape as long as the shape extends in the direction along the Z-axis.

The base section 41 may constitute a part of the liquid level tube 42. By providing a light-transmissive cover member on the base section 41, the liquid level tube 42 may be configured by the base section 41 and the cover member.

The plurality of reference lines 41C may be provided on the liquid level tube 42 instead of the base section 41. The plurality of reference lines 41C may be provided on both the base section 41 and the liquid level tube 42. In the second embodiment, the liquid level detection unit 40 may not include the plurality of reference lines 41C.

If the liquid level tube 42 is provided with the liquid level tube atmosphere opening section 47, the liquid level detection unit 40 does not have to include the communication section 44 and does not have to communicate with the tank 30. By this, the communication path 52 may not be provided and the communication path 52 may not be routed.

The liquid level detection unit 40 includes the communication section 44 and, as long as the liquid level tube 42 and the tank atmosphere opening section 33 communicate with each other, the liquid level tube 42 does not need to be provided with the liquid level tube atmosphere opening section 47. This enables the tank atmosphere opening section 33 to share the air opening between the liquid level tube 42 and the tank 30. In this way, the liquid level tube 42 may be open to atmosphere in the upward direction Z1.

The moisture-permeable membrane 48 may be provided in the communication section 44. The moisture-permeable membrane 48 may be provided in both the liquid level tube atmosphere opening section 47 and the communication section 44.

The liquid ejection device 11 may include one or more tanks 30, one or more flow paths 51, and one or more communication paths 52. The liquid level detection unit 40 may include one or more liquid level tubes 42, one or more inflow sections 43, and one or more communication sections 44.

The liquid level detection unit 40 may be disposed in any direction as long as the liquid level tube 42 is disposed to extend in the direction along the Z-axis. Therefore, in the above embodiment, the direction along the X-axis and the direction along the Y-axis with respect to the liquid level detection unit 40 may be any direction.

The predetermined position may be a position where the liquid ejection head 15 is disposed when the carriage 16 is disposed in the retraction region 19. The retraction region 19 may be provided on the second width direction X2 of the print region 18.

The liquid ejection head 15 may be a line type head. In a line type head, the liquid ejection head 15 is provided so as to be elongated along the width of the medium 99, and printing is performed by ejecting liquid onto the medium 99. In the first embodiment, when the liquid ejection head 15 is a line type head, the liquid level detection unit 40 and the plurality of tanks 30 may be provided so as to straddle a virtual line in which the liquid ejection head 15 extends in the direction along the Y-axis.

The linear image sensor constituting the reading section 45 may be a CMOS image sensor, a metal oxide semiconductor (MOS) image sensor, or a charge coupled device (CCD) image sensor. The image sensor constituting the reading section 45 may be an area image sensor.

The medium 99 may be a paper sheet, a film or sheet made of resin, a composite film of resin and metal, a laminated film, a woven fabric, a nonwoven fabric, a metal foil, a metal film, a ceramic sheet, clothing, or the like.

The liquid can be arbitrarily selected as long as the liquid can be printed on the medium 99 by adhering to the medium 99. For example, the ink includes ink in which particles of functional material made of solid material such as pigment or metal particles are dissolved, dispersed, or mixed in a solvent, and includes various compositions such as water-based ink, oil-based ink, gel ink, and hot-melt ink.

As used herein, the phrase “at least any” means one or more of the desired options. As an example, if the number of options is two, the phrase “at least any of” as used herein means only one option or both of the two options. As another example, if the number of options is three or more, the phrase “at least any” as used herein means only one option or a combination of any two or more options.

### Appendix

Hereinafter, technical concepts grasped from the above-described embodiment and modifications, and operations and effects thereof will be described. The present technical concept and the operational effects thereof can be combined with each other within a technically consistent range.

(1) The liquid level detection unit includes a liquid level tube extending along a height direction and opening to atmosphere in an upward direction; an inflow section connected to a flow path that causes liquid to flow into the liquid level tube from a tank connected to a liquid ejection head that ejects liquid; a reading section that outputs to a control section a reading result obtained by reading the liquid level of the liquid in the liquid level tube; and a base section in which the liquid level tube, the inflow section, and the reading section are provided, wherein the liquid level tube is light-transmissive.

According to this configuration, the liquid level of the liquid in the tank and the liquid level of the liquid that has flowed into the liquid level tube are the same. Therefore, the liquid level of the liquid inside the tank can be read by the reading section reading the liquid level of the liquid that flowed into the liquid level tube. By this, the installation location of the liquid level detection unit is not limited to the side surface of the tank. Therefore, even in a state where the liquid level detection unit is installed at a position separated from the tank, the liquid level of the liquid in the tank can be read. Therefore, the installation flexibility of the liquid level detection unit can be improved.

(2) The liquid level detection unit may be such that the liquid level detection unit includes a plurality of the liquid level tubes and a plurality of the inflow sections for causing the liquid to flow from the plurality of tanks into the plurality of liquid level tubes.

According to this configuration, the reading section reads the liquid level of the liquid that has flowed into the plurality of liquid level tubes, and thus the liquid level of the liquid in the plurality of tanks corresponding to the plurality of liquid level tubes can be read.

(3) The liquid level detection unit may further include a plurality of reference lines indicating a reference of a liquid level of the liquid level tube so as to be aligned in the height direction of the liquid level tube, wherein the reading section is a camera.

According to this configuration, the liquid level in the liquid level tube can be read by imaging the liquid level tube with the camera. By this, the liquid level detection unit can be provided with a simple configuration. In addition, by imaging the plurality of reference lines together with the liquid level tube with the camera, it is possible to capture an image that improves the detection accuracy of the liquid level in the liquid level tube with reference to the plurality of reference lines.

(4) Liquid level detection unit may be such that the base section has a first surface, the liquid level tube and the camera are provided at the first surface side, the camera images the liquid level tube from a first direction, and the first direction is a direction inclined from a perpendicular direction that is perpendicular to the first surface.

According to this configuration, the camera can be disposed on the base section side by side with the liquid level tube, rather than in front of the liquid level tube. This enables the liquid level detection unit to be made more compact in the perpendicular direction than in a case where the camera is installed in front of the liquid level tube. Therefore, the installation flexibility of the liquid level detection unit can be improved.

(5) The liquid level detection unit may be such that the reading section is a linear image sensor the base section has a first surface, the liquid level tube and the linear image sensor are provided at the first surface side; and the linear image sensor is provided so as to overlap the liquid level tube when viewed from a perpendicular direction that is perpendicular to the first surface.

According to this configuration, the liquid level detection unit can be downsized in the perpendicular direction as compared with a case where the reading section is a camera. Compared to a case where the reading section is a camera, the liquid level detection unit can be downsized also in the direction intersecting the height direction and the perpendicular direction. Therefore, the installation flexibility of the liquid level detection unit can be improved.

(6) The liquid level detection unit may be such that the liquid level liquid level tube has a liquid level tube atmosphere opening section in the upward direction.

According to this configuration, the liquid level tube can be open to atmosphere by providing the liquid level tube atmosphere opening section in the upward direction of the liquid level tube. This enables the liquid to flow smoothly from inside the tank into the liquid level tube.

(7) The liquid level detection unit may further include a moisture-permeable membrane covering the liquid level tube atmosphere opening section.

This configuration enables the liquid inside the liquid level tube to be suppressed from leaking to the outside from the liquid level tube atmosphere opening section.

(8) The liquid level detection unit may further include a communication section that communicates the liquid level tube with a tank atmosphere opening section provided in the upward direction of the tank.

According to this configuration, the liquid level tube and the tank atmosphere opening section can be made to communicate with each other by providing the communication section. This enables the liquid level tube to be open to atmosphere. Therefore, the liquid can be smoothly flowed into the liquid level tube from the inside of the tank.

(9) A liquid ejection device includes a liquid ejection head that ejects a liquid, and a tank connected to the liquid ejection head; a liquid level detection unit for detecting a liquid level of the liquid in the tank; a flow path for guiding the liquid to flow from the tank into the liquid level detection unit; and a control section, wherein the liquid level detection unit includes a liquid level tube extending along a height direction and opening to atmosphere in an upward direction, an inflow section to which the flow path is connected, a reading section that outputs to the control section a reading result obtained by reading the liquid level of the liquid in the liquid level tube, and a base section in which the liquid level tube, the inflow section, and the reading section are provided, the liquid level tube is light-transmissive, and the control section detects a liquid level of the liquid in the tank based on a reading result by the reading section.

According to this configuration, the same effect as that of (1) can be achieved.

(10) The liquid ejection device may be such that the reading section is a camera, the base section has a first surface,

the liquid level tube and the camera are provided at the first surface side, the camera images the liquid level tube from a first direction, the first direction is a direction inclined from a perpendicular direction that is perpendicular to the first surface, and the control section corrects, according to an inclination angle of the first direction with respect to the perpendicular direction, a captured image captured by the camera to a corrected image that is from the perpendicular direction.

According to this configuration, the same effect as that of (4) can be achieved. In addition, even when the camera captures an image of the liquid level tube from the first direction inclined from the perpendicular direction, the captured image can be corrected to a corrected image that is from the perpendicular direction. This enables the detection accuracy of the liquid level inside the liquid level tube to be improved based on the corrected image.

(11) Liquid ejection device, wherein a liquid ejection device includes a plurality of the tanks and a plurality of the flow paths and the liquid level detection unit includes a plurality of the liquid level tubes and a plurality of the inflow sections.

According to this configuration, the same effect as that of (2) can be achieved.

(12) The liquid ejection device may be such that the plurality of tanks each have an inlet section into which the liquid is injected.

According to this configuration, it is possible to detect the liquid level of the liquid in the tank that can be replenished with the liquid from the outside via the inlet section.

(13) The liquid ejection device may further include a transport path along which the medium is transported in a transport direction, wherein one or more tanks of the plurality of tanks and the liquid level detection unit are provided at positions sandwiching the transport path in a width direction intersecting the transport direction.

According to this configuration, one or more tanks among the plurality of tanks and the liquid level detection unit can be disposed at different positions with the transport path interposed between them. Therefore, the installation flexibility of the liquid level detection unit can be improved.

(14) The liquid ejection device may be such that at least a portion of the liquid level detection unit overlaps at least a portion of the one or more tanks when viewed from the width direction.

According to this configuration, the flow path connecting the liquid level detection unit and the one or more tanks can be shortened compared to a case where the liquid level detection unit and the one or more tanks do not overlap when viewed from the width direction. Therefore, it is possible to suppress an increase in the size of the device.

(15) The liquid ejection device may be such that the liquid ejection head is movable along a width direction intersecting the height direction, and the plurality of tanks and the liquid level detection unit are provided at positions sandwiching a moving range of the liquid ejection head in a front-rear direction intersecting the height direction and the width direction.

According to this configuration, the plurality of tanks and the liquid level detection unit can be disposed at different positions sandwiching the moving range of the liquid ejection head. Therefore, the installation flexibility of the liquid level detection unit can be improved.

(16) The liquid ejection device may be such that at least a portion of the liquid level detection unit overlaps at least a portion of the plurality of tanks when viewed from the front-rear direction.

According to this configuration, the flow path connecting the liquid level detection unit and the plurality of tanks can be shortened compared to a case where the liquid level detection unit and the plurality of tanks do not overlap when viewed from the front-rear direction. Therefore, it is possible to suppress an increase in the size of the device.

What is claimed is:

1. A liquid level detection unit comprising:
a liquid level tube extending along a height direction and opening to atmosphere in an upward direction;
an inflow section connected to a flow path that causes liquid to flow into the liquid level tube from a tank connected to a liquid ejection head that ejects liquid;
a reading section that outputs to a control section a reading result obtained by reading the liquid level of the liquid in the liquid level tube; and
a base section in which the liquid level tube, the inflow section, and the reading section are provided, wherein the liquid level tube is light-transmissive.

2. The liquid level detection unit according to claim 1, wherein
liquid level detection unit includes
a plurality of the liquid level tubes and
a plurality of the inflow sections for causing the liquid to flow from the plurality of tanks into the plurality of liquid level tubes.

3. The liquid level detection unit according to claim 1, further comprising:
a plurality of reference lines indicating a reference of a liquid level in the liquid level tube so as to be aligned in the height direction of the liquid level tube, wherein
the reading section is a camera.

4. The liquid level detection unit according to claim 3, wherein
the base section has a first surface,
the liquid level tube and the camera are provided at the first surface side,
the camera images the liquid level tube from a first direction, and
the first direction is a direction inclined from a perpendicular direction that is perpendicular to the first surface.

5. The liquid level detection unit according to claim 1, wherein
the reading section is a linear image sensor,
the base section has a first surface,
the liquid level tube and the linear image sensor are provided at the first surface side, and
the linear image sensor is provided so as to overlap the liquid level tube when viewed from a perpendicular direction that is perpendicular to the first surface.

6. The liquid level detection unit according to claim 1, wherein
the liquid level tube has a liquid level tube atmosphere opening section in an upward direction.

7. The liquid level detection unit according to claim 6, further comprising:
a moisture-permeable membrane covering the liquid level tube atmosphere opening section.

8. The liquid level detection unit according to claim 1, further comprising:
the tank further includes a communication section that connects the liquid level tube with a tank atmosphere opening section provided in an upward direction of the tank.

9. A liquid ejection device comprising:
a liquid ejection head configured to eject a liquid;
a tank connected to the liquid ejection head;
a liquid level detection unit for detecting a liquid level of the liquid in the tank;
a flow path for guiding the liquid to flow from the tank into the liquid level detection unit; and
a control section, wherein
the liquid level detection unit includes
a liquid level tube extending along a height direction and opening to atmosphere in an upward direction,
an inflow section to which the flow path is connected,
a reading section that outputs to the control section a reading result obtained by reading the liquid level of the liquid in the liquid level tube, and
a base section in which the liquid level tube, the inflow section, and the reading section are provided,
the liquid level tube is light-transmissive, and
the control section detects a liquid level of the liquid in the tank based on a reading result by the reading section.

10. The liquid ejection device according to claim 9, wherein
the reading section is a camera,
the base section has a first surface,
the liquid level tube and the camera are provided at the first surface side,
the camera images the liquid level tube from a first direction,
the first direction is a direction inclined from a perpendicular direction that is perpendicular to the first surface, and
the control section corrects, according to an inclination angle of the first direction with respect to the perpendicular direction, a captured image captured by the camera to a corrected image that is from the perpendicular direction.

11. The liquid ejection device according to claim 9, wherein
a liquid ejection device includes
a plurality of the tanks and
a plurality of the flow paths and
the liquid level detection unit includes
a plurality of the liquid level tubes and
a plurality of the inflow sections.

12. The liquid ejection device according to claim 11, wherein
the plurality of tanks include an inlet section into which a liquid is injected.

13. The liquid ejection device according to claim 11, further comprising:
a transport path along which the medium is transported in a transport direction, wherein
one or more tanks of the plurality of tanks and the liquid level detection unit are provided at positions sandwiching the transport path in a width direction intersecting the transport direction.

14. The liquid ejection device according to claim 13, wherein
at least a portion of the liquid level detection unit overlaps at least a portion of the one or more tanks when viewed from the width direction.

15. The liquid ejection device according to claim 11, wherein
the liquid ejection head is movable along a width direction intersecting the height direction and
the plurality of tanks and the liquid level detection unit are provided at positions sandwiching a moving range of the liquid ejection head in a front-rear direction intersecting the height direction and the width direction.

16. The liquid ejection device according to claim 15, wherein
at least a portion of the liquid level detection unit overlaps at least a portion of the plurality of tanks when viewed from the front-rear direction.
